(19) United States
(12) Patent Application Publication
(10) Pub. No.: US 2020/0184457 A1
(43) Pub. Date: Jun. 11, 2020

(54) METHOD FOR FACILITATING PAYMENT USING INSTANT MESSAGING APPLICATION

(71) Applicant: MASTERCARD INTERNATIONAL INCORPORATED, Purchase, NY (US)

(72) Inventors: Syam Sasidharan Nair, Singapore (SG); John Florinis, Markham (CA); Chee Leong Liew, Singapore (SG); Holger Kunkat, Neumuenster (DE); Sachin Ahuja, Millstone Township, NJ (US)

(21) Appl. No.: 16/314,284

(22) PCT Filed: Jun. 29, 2017
(86) PCT No.: PCT/US17/40006

§ 371 Date: Dec. 28, 2018

(30) Foreign Application Priority Data
Jul. 1, 2016 (SG) 10201605438W

(51) Int. Cl. G06Q 20/32; G06Q 20/42; G06Q 20/36

(52) U.S. Cl. CPC G06Q 20/3255; G06Q 20/3678; G06Q 20/42; G06Q 20/3223

(57) ABSTRACT

A method for facilitating payment using instant messaging application is provided. The method includes establishing, in the instant messaging application, an order with a merchant, the order including an order value, receiving from the instant messaging application, confirmation that payment of the order value should be made using a digital wallet, and sending confirmation of payment from the digital wallet to the merchant after payment of the order value has been made.

### CROSS REFERENCE TO RELATED APPLICATIONS

This patent application is a National Stage Entry of PCT/US2017/040006 filed on Jun. 29, 2017, which claims the benefit and priority of Singapore Application No. 10201605438 W filed on Jul. 1, 2016, the disclosures of which are incorporated herein by reference in their entirety as part of the present application.

### BACKGROUND

The present disclosure relates broadly, but not exclusively, to methods and systems for facilitating payment using an instant messaging application.

Instant messaging applications typically offer real-time text transmission over the Internet. In general, short messages are transmitted bi-directionally between two parties. Recently, more advanced instant messaging application can transfer images and videos and permit multi-party conversations.

As a result of advancements in artificial intelligence, natural language user interfaces are available for instant messaging applications. Users are thus now able to interact with bots that run automated tasks (scripts) over the Internet using natural language. When interacting with a bot via an instant messaging application, the users can communicate with the bot as if the users were communicating with a human. Utilizing such bots advantageously enables an enormous amount of work to be handled which may be an insurmountable task if endeavored to be handled by human.

However, utilization of such bots for commercial purpose is limited. For many interactions bots will display an Internet link, require the user to download a document or open a different app to complete their interaction. For example, when booking flights, a bot will direct the user to a booking page rather than complete the booking within the instant messaging application.

A need therefore exists to improve the functionality of instant messaging applications to reduce the need for users to interact with third party applications and other documentation outside the instant messaging application.

### BRIEF DESCRIPTION

A first aspect of the present disclosure provides a method for facilitating payment using an instant messaging application. The method includes establishing, in the instant messaging application, an order with a merchant, the order including an order value, receiving, from the instant messaging application, confirmation that payment of the order value should be made using a digital wallet, and sending confirmation of payment from the digital wallet to the merchant after payment of the order value has been made.

A second aspect of the present disclosure provides a system for facilitating payment using an instant messaging application. The system includes an order establishing module for establishing, in the instant messaging application, an order with a merchant, the order including an order value, a receiver for receiving, from the instant messaging application, confirmation that payment of the order value should be made using a digital wallet, and a transmitter for sending confirmation of payment from the digital wallet to the merchant after payment of the order value has been made.

Unless context dictates otherwise, the following terms will be given the meaning provided here:

“payment vehicle” includes a credit card, debit card, virtual card, bank account, prepaid card, or any other payment vehicle from which funds can be debited to affect a transaction.

“establishing an order” is confirming the order should be placed and order is deemed “complete” when the customer determines that the item, or all items, they intend to purchase have now been added to the order and no further changes are warranted.

“order value” refers to a total amount to be paid by the customer for purchase of the item or all items in the order.

“messenger app” or “instant messaging application” refers to any type of online chat which offers real-time text or voice transmission over the Internet.

“one or more databases” refers to any database or databases located within a computing system or remote server such as a cloud server. The database or databases may each be a cloud database running on a cloud computing platform.

### BRIEF DESCRIPTION OF THE DRAWINGS

Embodiments of the disclosure will be better understood and readily apparent to one of ordinary skill in the art from the following written description, which provides examples only, and in conjunction with the drawings in which:

FIG. 1 shows a flow chart illustrating a method for facilitating payment using an instant messenger application according to the present disclosure;

FIG. 2 shows a detailed workflow illustrating transactions between a messenger app, digital wallet, and merchant according to the present disclosure;

FIG. 3 shows user interfaces on an instant messaging application for payment of order value according to the present disclosure;

FIG. 4 shows user interfaces on an instant messaging application for registration of digital wallet during payment of order value according to the present disclosure;

FIG. 5 shows user interfaces on a registration of digital wallet prior to ordering items according to the present disclosure;

FIG. 6 shows a schematic of a system for facilitating payment using an instant messenger application according to the present disclosure; and

FIG. 7 shows an exemplary computing device suitable for executing the method for facilitating payment using an instant messenger application according to the present disclosure.

### DETAILED DESCRIPTION

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic, or optical signals capable of being stored, transferred, combined, compared, and otherwise manipulated.

Unless specifically stated otherwise, and as apparent from the following, it will be appreciated that throughout the present specification, discussions utilizing terms such as “receiving”, “establishing”, “sending”, “identifying”, “producing” or the like, refer to the action and processes of a computer system, or similar electronic device, that manipulates and transforms data represented as physical quantities within the computer system into other data similarly represented as physical quantities within the computer system or other information storage, transmission, or display devices.

The present disclosure also provides apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present disclosure also implicitly provides a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the example method.

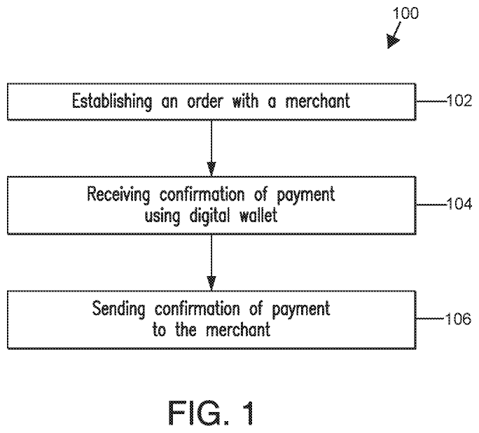

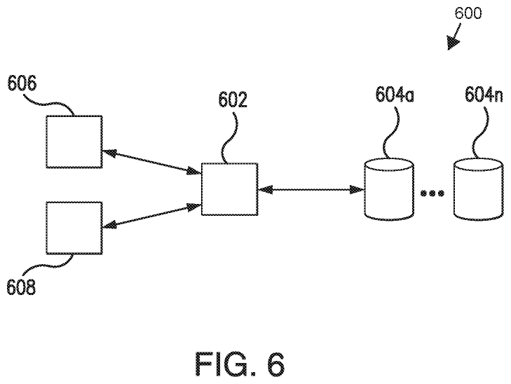

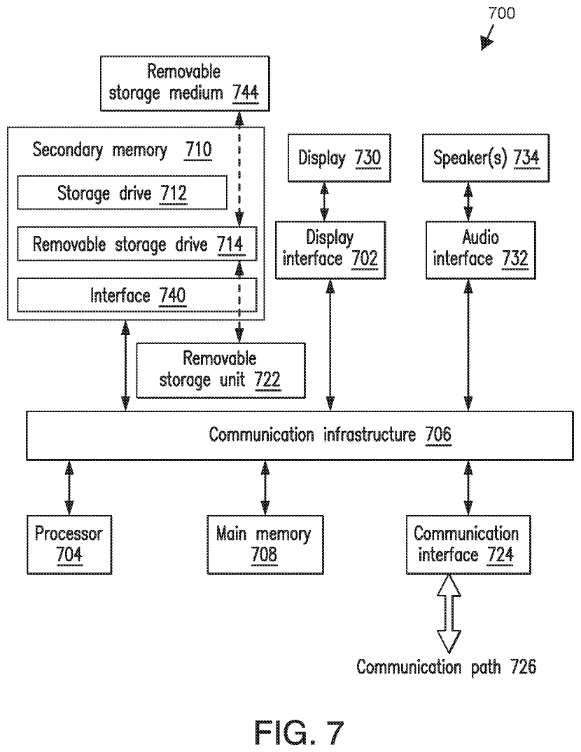

FIG. 1 shows a flow chart illustrating a method 100 for facilitating payment using an instant messaging application, according to an embodiment of the disclosure. The method 100 may be performed by a computer coupled to one or more databases. Furthermore, the method 100 may be performed by a computing device which may be a server system, mobile device (e.g., a smart phone or tablet computer) or a personal computer. Further details on the computer and databases will be provided below with reference to FIGS. 6 and 7.

The method 100 broadly includes:

Step 102: establishing, in the instant messaging application, an order with a merchant, the order including an order value;

Step 104: receiving, from the instant messaging application, confirmation that payment of the order value should be made using a digital wallet; and

Step 106: sending confirmation of payment from the digital wallet to the merchant after payment of the order value has been made.

Without loss of generality, the description will largely focus on embodiments of the disclosure relating to digital wallet integrated into an instant messaging application, though it will be understood to apply equally to other payment means integrated into the instant messaging application.

Step 102 involves establishing, in the instant messaging application, an order with a merchant. The order includes an order value. In an example, a user is communicating with a bot, provided by the merchant, using natural language. That communication involves an exchange of instant messages between the user and the bot. During that exchange, the bot receives an order from the user through the instant messaging application. This may be achieved by the bot identifying one or more items in the instant messages sent by the user, or by providing the user options for purchase. For example, the user may send a message saying “I feel like a burger and fries for lunch” or “I feel like ordering my ‘usual’ for lunch”. The bot may instead initiate the communication, stating “Would you like to place your usual order?”.

As a result, the bot can identify the item or items that make up the order. The bot can therefore place the order with the merchant on behalf of the user.

The bot may be configured to detect the intent of the user, such as the intention to pay. For example, after the user has ordered some food the bot may ask “Would you like a drink?” or “Would you like anything else?”. If the user responds with a phrase to the effect of “No. That's it.” Or “That's all.” the bot will understand the order is established. Similarly, the user may demonstrate intent in a manner other than in response to a prompt from the bot. For example, the user may send an instant message saying “pay now”, “pay” or “nothing else” and the bot will understand the order is established.

To ensure the order is correct, the bot may repeat the order to the user (e.g., in an instant message or through an audio output in which the order is recited to the user) and seek confirmation that the order is correct. The confirmation may be sent in the form of an instant message from the user, or by receiving selection of, for example, a confirmation button displayed in an instant message supplied by the bot or by the instant messaging application. Once the order is confirmed by the user, the order with a merchant is established in the instant messaging application.

The bot then advises the messenger application that the order is established. This may involve use of application programming interfaces (APIs) by which the bot interacts with the messenger app. The messenger app then sends an order request to the digital wallet, the order request identifying that an order has been placed through the messenger app. The order request may include order details (e.g., order value, merchant ID, items in the order, etc.) or may simply be a request to facilitate payment. In response, the digital wallet may cause an instant message to be displayed through which payment for the order can be confirmed per step 104.

Alternatively, the user may indicate to both the bot and messenger app that the order has been established by selecting a payment button or control provided on the messenger app. Selection of the button or control results in the messenger app sending the order request to the digital wallet.

In an example, the communication between the bot and the user is conducted via voice conversational interface including speech recognition engine and voice synthesis engine. If an order from the user is unclear, the bot may seek for additional information from the user to clarify the order. If there are some options which have not been selected by the user yet, the bot may ask the user which options to be selected. For example, if the user orders a meal that includes food and a drink but does not specify the drink, the bot may ask “Pepsi or Coke” to clarify a drink accompanying the meal.

If any customer loyalty programs are linked to the instant messaging application, the bot may check the existing reward points of the user, or loyalty awards to which the user is entitled, by accessing to a remote value-added services server and retrieve information specifying any rewards or awards the user may use in the order. The instant messenger app may then display an instant messaging advising the user of the rewards and awards to which they are entitled and ask the user whether or not redeem the any reward or award. For example, the bot may draw the customer's attention to the existing points as follows: “Don't forget to redeem your 500 points to get free chicken nuggets”. If there are any promotions which may be useful for the customers, the bot may draw the customer's attention to the promotion in a similar manner.

The bot serves as an intermediary between the user and the merchant or, in a different sense, as an agent for the merchant. The bot has access to items sold by the merchant and can retrieve product information from a merchant server hosted by the merchant. For example, the bot may have knowledge of items of food sold by the merchant, nutritional information, and pricing information. As such, when a user places an order the bot can recognize the particular item or items contained in the order by cross-reference those items (or words from the instant message containing the order) against the items sold by the merchant (or from previous purchases made by the user). The bot can then retrieve the price for each item and other information (e.g., nutritional information in the case of food) relevant to the order for display to the user in an instant message.

The instant messaging application may utilize geolocation information obtained from GPS of the user's smartphone to facilitate the provision of services by merchants. For example, based on the geolocation information, the bot may locate the nearest branch for the user to pick up the items purchased by the user. For delivery of the items purchased by the user, it is useful to register a residential address and/or a company address in advance. The user may provide the address for delivery to the bot during conversation for ordering the items. The instant messenger application may supply the shipping and/or billing address to the merchant before, during, or on completion of, the order.

Step 104 may include receiving, from the instant messaging application, confirmation that payment of the order value should be made using a digital wallet. In an example, the bot displays the total amount to be paid. This enables the user to verify the amount for the order before paying for the order.

The bot also displays a pay button to be tapped by the user in the instant messaging application. When the user taps the pay button, a registered digital wallet together with a default payment vehicle of the digital wallet is displayed in the instant messaging application. A registered digital wallet is therefore a digital wallet that has been authorized by the user for use in making purchases through the instant messenger application. If multiple payment vehicles are registered to the digital wallet, a button e.g., “choose a different card” is also displayed for selection from the multiple payment vehicles. By tapping the button “choose a different card”, multiple payment vehicles are displayed to be selected by the user.

The instant messaging application may display a password entry field upon receipt of confirmation that the order should be paid or placed. The password entry field may include the field into which text is usually entered when producing an instant message. When using the password entry field to facilitate payment, the password entry field may include default text identifying to the user that their password should be entered, for example, the entry field may display “Enter Password”. The password may then be entered in the instant messaging application to proceed with the payment. The password is then matched against a password stored by the instant messaging application, or by the digital wallet provider. Requiring entry of a password provides some security that the user placing the order is authorized to place the order. In other words, the password can be used to authenticate the user. Other types of user authentication may be user in addition to, or in place of, a password such as finger print recognition or Iris recognition etc. The user may be able to change the setting of the application to avoid entering password or user authentication.

If there is no digital wallet registered to the instant messaging application, the user may register a digital wallet in the instant messaging application during purchasing procedures. In such a case, a registration page of the digital wallet, instead of a registered digital wallet together with a default payment vehicle, is displayed in the instant messaging application in response to tapping the pay button. This enables the user to enter their information into the instant messenger application in order to register a digital wallet for use in purchases made through the instant messenger application. Accordingly, it is not necessary to switch to a digital wallet application or any other application for registration of the digital wallet. For registration, one or more of the following is required: account name (e.g., e-mail address or phone number), payment vehicle details (e.g., card number, expiry, CVV of a credit, or debit card) and billing address for the payment vehicle. Once the registration is completed and the digital wallet is registered to the instant messaging application, the user can proceed with the payment using the registered digital wallet.

Alternatively, the user may register a digital wallet to the instant messaging application prior to ordering any items. In an example, the user may tap a “manage payment” button in a settings screen of the instant messaging application. In response to tapping the “manage payment” button, a registration page of the digital wallet is displayed. Similar to the process for registering a digital wallet while placing an order, one or more of the following is required for registration: account name (e.g., e-mail address or phone number), payment vehicle details (e.g., card number, expiry, CVV of a credit, or debit card) and billing address for the payment vehicle. Once the registration is completed and the digital wallet is registered to the instant messaging application, the user can proceed with the payment in the instant messaging application.

Step 106 involves sending confirmation of payment from the digital wallet to the merchant after payment of the order value has been made. The digital wallet receives payment information and authentication information such as a password or scanned fingerprint from the bot in the instant messaging application. Once the authentication information provided by the user is matched with the authentication information stored in an instant messaging application or stored by the digital wallet provider, the payment is approved in the digital wallet. The digital wallet then processes settlement in the usual manner and confirmation is provided to the merchant (e.g., by the digital wallet or by the merchant's acquirer) when settlement has been made. The digital wallet or the bot may also display an instant message in the instant messaging app advising that payment has been made (i.e., settlement has been affected).

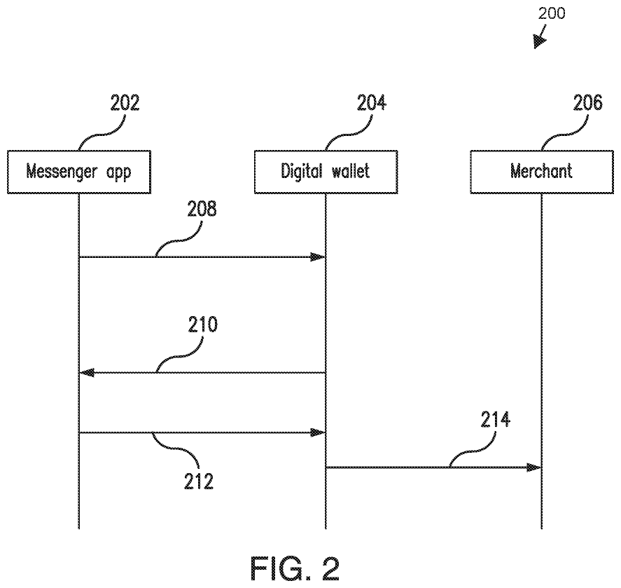

FIG. 2 shows a detailed workflow 200 illustrating transactions between a messenger app 202, digital wallet 204, and merchant 206 according to the present disclosure. The instant messenger application 202 may be installed on a user's device such as a smartphone or other portable electronic device, or PC. Digital wallet 204 is also installed on the user's device and registered to the instant messenger application 202. The application can therefore communicate with the digital wallet 204, which in turn can communicate with digital wallet provider to affect payment. The merchant 206 will receive information from the instant messenger application 202 and/or digital wallet 204 via any types of communication means, e.g., instant message or email.

Once an order with the merchant is established, the messenger app 202 sends a request to digital wallet 204 to display a payment button for the user to tap and pay for order value in the messenger app 202 in step 208 (i.e., a button through which the user confirms their desire to pay for the order). In response, digital wallet 204 displays the payment request for order value in the messenger app 202 in step 210. To facilitate the payment, the payment request is provided together with digital wallet 204 and a default payment vehicle in the instant messenger application 202. For example, the digital wallet 204 may cause the instant messenger app 202 to display an instant message including the payment mark of the digital wallet 204. The digital wallet 204 may cause the instant messenger app 202 to display payment vehicle details of the default payment vehicle used with the digital wallet (e.g., a partial credit card number for a credit card contained in the digital wallet). The digital wallet 204 may cause the instant messenger app 202 to display a payment request such as a payment confirmation button or password field the selection of the button or entry of a password resulting in payment being processed through the digital wallet 204. The user therefore does not need to switch from the messenger app to the digital wallet app, or from the messenger app to a payment gateway, to pay for the order.

Once the instant messenger app 202 receives confirmation that payment should be made, it sends a notification to the digital wallet 204 to settle the order. That notification may include a merchant identifier that identifies the merchant or a bank account of the merchant, an order number for identifying the order, the order value, and/or the items which the order includes.

Receiving confirmation that the order should be paid may include receiving selection of a payment vehicle contained in the digital wallet, for use in making payment. This can be useful where the default payment vehicle is not the payment vehicle desired to be used in the transaction.

Payment vehicle details (e.g., card number, expiry, CVV of a credit or debit card) of the selected payment vehicle are sent to digital wallet 204 in step 212. If authentication is required, authentication information such as a password or scanned representation of a fingerprint or iris may also sent to digital wallet 204 in step 212. If the authentication information is matched to the information stored in the instant messaging application or stored by the digital wallet provider and the payment using the selected payment vehicle is confirmed (i.e., the digital wallet has been notified of settlement), payment confirmation is sent to merchant 206 in step 214. The merchant 206 may then start the process for delivering of the items contained in the order. The merchant may send an estimated delivery date and/or time to the user via instant messaging application or email. The merchant 206 may also provide periodic updates in the form of instant messages displayed in the instant messenger app 202, advising the user of the status of the order, for example, the merchant 206 may send a sequence of messages, at different relevant times, stating “Order being prepared”, “Order packed”, “Order being delivered” and “Order successfully delivered”.

In the present teaching, “the items contained in the order” and similar phrases refer to the items to be purchased by the customer or user. Upon receiving confirmation of payment, the merchant will proceed to deliver the items to the customer. If the items contained in the order include a ticket for an event, airline, or movie etc., the merchant may issue an electronic ticket (e-ticket) immediately after receiving confirmation of payment and send it via the instant messaging application or any other type of communication means (e.g., text message or email). If the items contained in the order involve digital media, such as music, electronic books or software etc., the merchant may deliver the digital media immediately after receiving confirmation of payment. If the item or items contained in the order include a request for a booking such as a taxi booking, the merchant may assign a taxi to the customer and inform the customer of estimated waiting time for the taxi via an instant message in the instant messenger app.

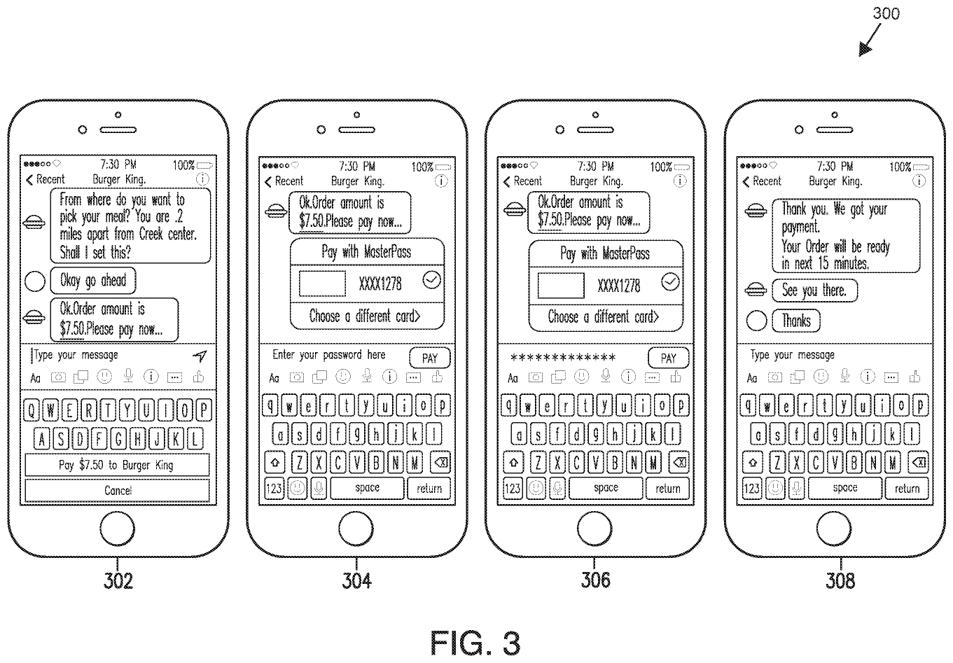

FIG. 3 shows user interfaces 300 on an instant messaging application for payment of an order value according to the present disclosure. In 302, the user confirms the order with the merchant and the instant messaging application displays a payment button “Pay $7.50 to Burger King” to be tapped by the user for payment. As shown in 304, a digital wallet is shown as “Pay with MasterPass” in response to tapping the payment button. The user will type a password at the field “Enter your password here” as shown in 306. If the entered password matches a password stored in the instant messaging application or stored by the digital wallet provider, payment confirmation is sent to the user via the instant messaging application as shown in 308.

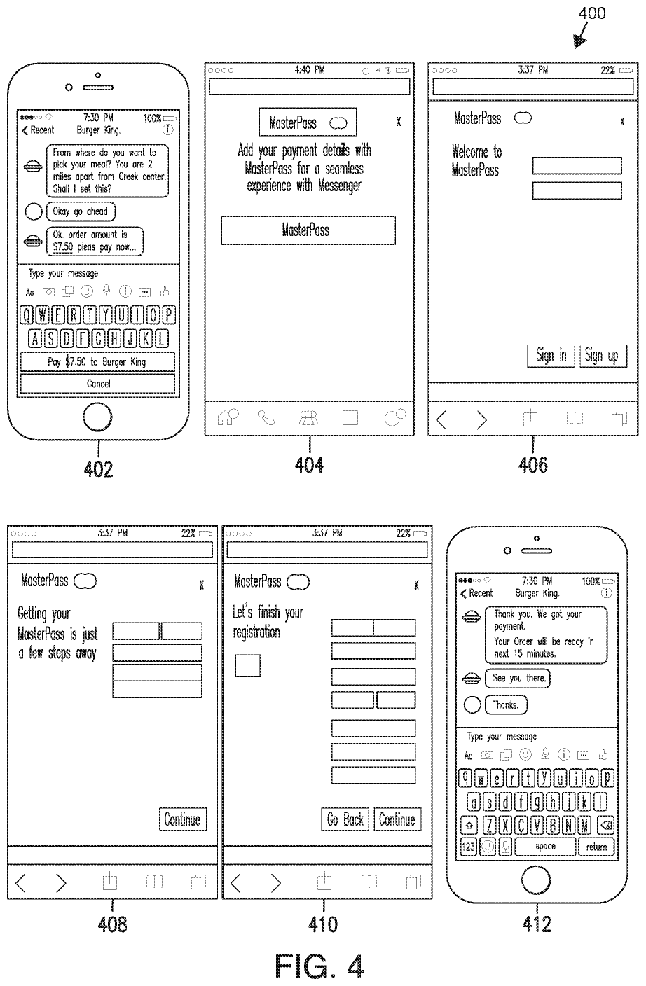

FIG. 4 shows user interfaces 400 on an instant messaging application for registration of digital wallet according to the present disclosure. In 402 the user confirms the order with the merchant and the instant messaging application displays a payment button “Pay $7.50 to Burger King” to be tapped by the user for payment. If no digital wallet is registered to the instant messaging application, a digital wallet registration page is displayed as shown in 404. In 406, an email address or telephone number is required to be entered. Upon entry of the email address or telephone number, payment vehicle details (e.g., card number, expiry, CVV of a credit or debit card) are required to be entered (see 408). Upon receipt of the payment vehicle details a billing address for the order is required to be entered (see 410). Once the digital wallet is registered to the messenger app and payment for the order has been completed, payment confirmation is sent to the user via instant messaging application as shown in 412.

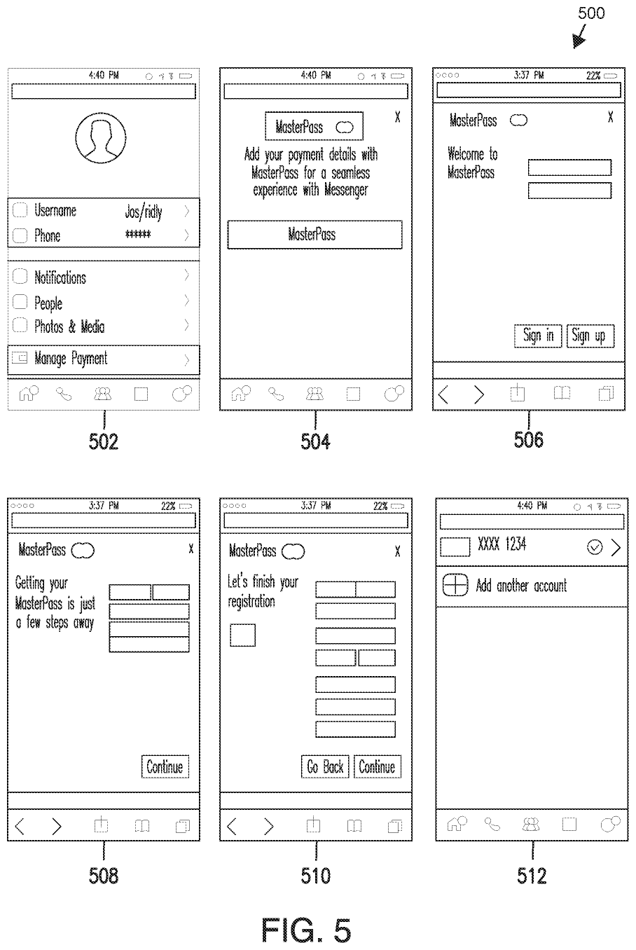

FIG. 5 shows user interface 500 for registration of a digital wallet according to the present disclosure. In 502, “manage payment” in setting screen of the instant messaging application is tapped to register a digital wallet to the instant messaging application. If no digital wallet is registered to the instant messaging application, a digital wallet registration page is displayed as shown in 504. In 506, email address or telephone number is required to be entered. In 508, payment vehicle details (e.g., card number, expiry, CVV of a credit or debit card) are required to be entered. In 510, billing address of the payment vehicle is required to be entered. If the registration for a digital wallet to the instant messaging application is completed, a registered payment vehicle in the digital wallet is shown in 512. The user may add another payment vehicle to the digital wallet if necessary.

FIG. 6 shows a schematic of a network-based system 600 for facilitating payment using an instant messaging application according to an embodiment of the present disclosure. The system 600 includes a computer 602, one or more databases 604a . . . 604n, a user input module 606, and a user output module 608. Each of the one or more databases 604a . . . 604n are communicatively coupled with the computer 602. The user input module 606 and a user output module 608 may be separate and distinct modules communicatively coupled with the computer 602. Alternatively, the user input module 606 and a user output module 608 may be integrated within a single mobile electronic device (e.g., a mobile phone, a tablet computer, etc.). The mobile electronic device may have appropriate communication modules for wireless communication with the computer 602 via existing communication protocols.

The computer 602 may include at least one processor, and at least one memory including computer program code, the at least one memory and the computer program code configured to, with at least one processor, cause the computer at least to: (A) establish, in the instant messaging application, an order with a merchant, the order including an order value, (B) receive from the instant messaging application, confirmation that payment of the order value should be made using a digital wallet, and (C) send confirmation of payment from the digital wallet to the merchant after payment of the order value has been made.

The various types of data, e.g., item information, payment information, location information, merchant information can be stored in a single database (e.g., 604a), or stored in multiple databases (e.g., item information are stored on database 604a, merchant information are stored on database 604n, etc.). The databases 604a . . . 604n may be realized using cloud computing storage modules and/or dedicated servers communicatively coupled with the computer 602.

FIG. 7 depicts an exemplary computer/computing device 700, hereinafter interchangeably referred to as a computer system 700, where one or more such computing devices 700 may be used to facilitate execution of the above-described method for facilitating payment using an instant messaging application. In addition, one or more components of the computer system 700 may be used to realize the computer 602. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a storage drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive, or a memory card), or the like. The removable storage drive 714 reads from and/or writes to a removable storage medium 744 in a well-known manner. The removable storage medium 744 may include magnetic tape, optical disk, non-volatile memory storage medium, or the like, which is read by and written to by removable storage drive 714. As will be appreciated by persons skilled in the relevant art(s), the removable storage medium 744 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 740. Examples of a removable storage unit 722 and interface 740 include a program cartridge and cartridge interface (such as that found in video game console devices), a removable memory chip (such as an EPROM or PROM) and associated socket, a removable solid state storage drive (such as a USB flash drive, a flash memory device, a solid state drive, or a memory card), and other removable storage units 722 and interfaces 740 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments of the disclosure, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port (such as a serial, parallel, printer, GPIB, IEEE 1393, RJ35, or USB), an antenna with associated circuitry and the like. The communication interface 724 may be wired or may be wireless. Software and data transferred via the communication interface 724 are in the form of signals which can be electronic, electromagnetic, optical, or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage medium 744, removable storage unit 722, a hard disk installed in storage drive 712, or a carrier wave carrying software over communication path 726 (wireless link or cable) to communication interface 724. Computer readable storage media refers to any non-transitory, non-volatile tangible storage medium that provides recorded instructions and/or data to the computing device 700 for execution and/or processing. Examples of such storage media include magnetic tape, CD-ROM, DVD, Blu-ray™ Disc, a hard disk drive, a ROM, or integrated circuit, a solid state storage drive (such as a USB flash drive, a flash memory device, a solid state drive, or a memory card), a hybrid drive, a magneto-optical disk, or a computer readable card such as a SD card and the like, whether or not such devices are internal or external of the computing device 700. Examples of transitory or non-tangible computer readable transmission media that may also participate in the provision of software, application programs, instructions, and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the storage drive 712, or the interface 740. Alternatively, the computer program product may be downloaded to the computer system 700 over the communications path 726. The software, when executed by the processor 704, causes the computing device 700 to perform functions of embodiments described herein.

It is to be understood that the embodiment of FIG. 7 is presented merely by way of example. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

1. A method for facilitating payment using an instant messaging application, the method comprising
establishing, in the instant messaging application, an order with a merchant, the order comprising an order value;
receiving, from the instant messaging application, confirmation that payment of the order value should be made using a digital wallet; and
sending confirmation of payment from the digital wallet to the merchant after payment of the order value has been made.

2. A method according to claim 1, wherein establishing an order comprises identifying, from content of an instant message in the instant messaging application, at least one item for purchase, wherein the order value is a total value for purchase of the at least one item.

3. A method according to claim 1, wherein establishing an order comprises identifying, from content of a voice message in the instant messaging application, at least one item for purchase, wherein the order value is a total value for purchase of the at least one item.

4. A method according to claim 1, wherein the order comprises at least one item for purchase, and wherein establishing an order comprises receiving confirmation that there are to be no further changes to the at least one item.

5. A method according to claim 1, wherein establishing an order comprises producing an instant message listing the at least one item contained in the order.

6. A method according to claim 1, wherein receiving confirmation that payment of the order should be made comprises displaying a confirmation message in the instant messaging application, the confirmation message requesting confirmation that the order value should be paid to settle the order.

7. A method according to claim 1, wherein receiving confirmation that payment of the order should be made comprises receiving a unique identifier to allow payment of the order value using the digital wallet.

8. A method according to claim 1, wherein sending confirmation comprises sending confirmation of payment from at least one of the digital wallet and the merchant to the instant messaging application.

9. A method according to claim 1, wherein the instant messaging application is installed on a device, and wherein the method further comprises checking whether a digital wallet is installed on the device and registered for use, with the instant messaging application, for processing payment orders made through the instant messaging application.

10. A method according to claim 9, further comprising displaying a digital wallet setup page in the instant messaging application, when no digital wallet is located on the device.

11. A method according to claim 10, further comprising receiving payment vehicle details through the digital wallet setup page, the payment vehicle details relating to a payment vehicle for use in paying the order value.

12. A method according to claim 1, further comprising issuing e-tickets in response to the confirmation of payment and sending the issued e-tickets to the instant messaging application.

13. A computing system for facilitating payment using an instant messaging application, the system comprising:
an order establishing module for establishing, in the instant messaging application, an order with a merchant, the order comprising an order value;
a receiver for receiving, from the instant messaging application, confirmation that payment of the order value should be made using a digital wallet; and
a transmitter for sending confirmation of payment from the digital wallet to the merchant after payment of the order value has been made.

14. A system for facilitating payment using an instant messaging application, comprising a computer, the computer comprising:
at least one processor; and
at least one memory including computer program code, wherein the at least one memory and the computer program code are configured to, with at least one processor, cause the computer at least to:
establish, in the instant messaging application, an order with a merchant, the order comprising an order value;
receive from the instant messaging application, confirmation that payment of the order value should be made using a digital wallet; and
send confirmation of payment from the digital wallet to the merchant after payment of the order value has been made.

15. The system according to claim 14, wherein the system is a mobile device.

16. A computer readable medium including computer program code for facilitating payment using an instant messaging application configured to, with at least one processor, cause a computer at least to:
establish, in the instant messaging application, an order with a merchant, the order comprising an order value;
receive from the instant messaging application, confirmation that payment of the order value should be made using a digital wallet; and
send confirmation of payment from the digital wallet to the merchant after payment of the order value has been made.
